(19) United States
(12) Patent Application Publication
(10) Pub. No.: US 2006/0028182 A1
(43) Pub. Date: Feb. 9, 2006

(54) Thermoelectric methods to control temperature of batteries

(76) Inventors: Jihui Yang, Lakeshore (CA); Kelly B. Ledbetter, Linden, MI (US); Francis R. Stabler, Troy, MI (US)

Correspondence Address: KATHRYN A. MARRA;General Motors Corporation, Legal Staff, Mail Code 482-C23-B21, P.O. Box 300, Detroit, MI, 48265-3000, US

(21) Appl. No.: 11/028,836

(22) Filed: Jan. 4, 2005

Related U.S. Application Data
(60) Provisional application No. 60/590,879, filed on Jul. 23, 2004.

(51) Int. Cl. H02J 7/04

(52) U.S. Cl. 320/150

(57) ABSTRACT

A method of controlling a temperature of a battery is disclosed. The method includes providing a thermoelectric device in thermally-conductive contact with the battery, measuring an actual temperature of the battery, comparing the actual temperature of the battery to a reference temperature for the battery, heating the battery by operation of the thermoelectric device when the actual temperature is less than the reference temperature and cooling the battery by operation of the thermoelectric device when the actual temperature exceeds the reference temperature.

This application claims the benefit of U.S. Provisional Application Ser. No. 60/590,879 filed Jul. 23, 2004.

### FIELD OF THE INVENTION

The present invention relates to thermoelectric devices which utilize electrical power to generate a thermal gradient. More particularly, the present invention relates to methods of controlling the temperature of batteries by using thermoelectric devices to cool or heat the batteries, as needed.

### BACKGROUND OF THE INVENTION

Thermoelectric (TE) technology has attracted worldwide interest in recent years. TE devices can be used for cooling and electrical power generation purposes in a variety of applications. While much of the work in thermoelectric technology has focused on the development of new thermoelectric materials, incorporation of the newly-developed materials into TE devices and practical application of the TE devices in automotive and other applications is also being investigated.

Batteries, including those used in automotive applications, are characterized by optimum operational temperature windows. During operation, high battery temperatures due to consecutive charge-discharge cycles, hot weather, engine heat, etc., are common. This results in a short battery lifespan and degraded battery performance. On the other hand, low battery temperatures encountered during cold startup conditions in cold weather, for example, prohibit efficient battery operation due to increased internal electrical resistance.

Thermoelectric technology includes heating and cooling capabilities of TE devices. The basis of such heating and cooling capabilities is the Peltier effect, which is expressed using a Peltier circuit. A Peltier circuit is a TE device which includes two thermally-opposite sides. When an electrical current is applied to the Peltier circuit in one direction, one side of the TE device creates heat, and therefore, has heating capability while the other side absorbs heat, and therefore, has cooling capability. Reversing the polarity of the electrical current applied to the Peltier circuit creates the opposite effect.

Accordingly, a control scheme or method is needed which utilizes a TE device to cool or heat a battery, as required, using the Peltier effect.

### SUMMARY OF THE INVENTION

The present invention is generally directed to thermoelectric methods which are suitable to control the temperature of batteries in a variety of applications. The methods include providing a thermoelectric device; providing a battery in thermally-conductive contact with the thermoelectric device; measuring a temperature of the battery; comparing the measured temperature of the battery to a desired reference temperature; and heating or cooling the battery, as necessary, using the Peltier effect by transmitting a current through the thermoelectric device in an appropriate direction.

### BRIEF DESCRIPTION OF THE DRAWINGS

The invention will now be described, by way of example, with reference to the accompanying drawings, in which:

FIG. 1 is a schematic of a battery temperature control scheme according to the present invention;

FIG. 2 is a schematic of a battery temperature control scheme according to an alternative embodiment of the present invention; and

FIG. 3 is a schematic of a battery temperature control scheme according to still another embodiment of the present invention.

### DETAILED DESCRIPTION OF THE INVENTION

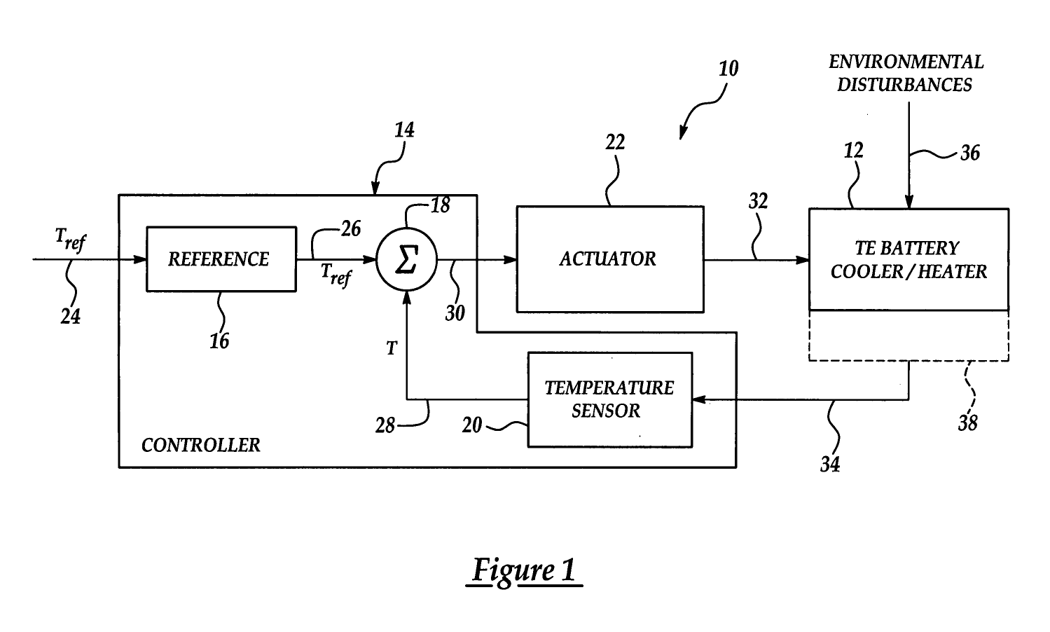

Referring initially to FIG. 1, an illustrative embodiment of a thermoelectric (TE) battery control system, hereinafter system, according to the present invention is generally indicated by reference numeral 10. The system 10 includes a thermoelectric (TE) device 12 having a conventional Peltier circuit (not shown). Responsive to flow of electrical current in one direction through the Peltier circuit, heat is generated at one side and absorbed at the opposite side of the TE device 12. When current flows in the opposite direction through the Peltier circuit, the hot and cold sides of the TE device 12 are reversed.

A battery 38, such as an automotive battery, for example, is provided in thermally-conductive contact with one side of the TE device 12. The battery 38 may be any type of battery including but not limited to a lead acid battery, a nickel metal hydride battery or a lithium ion battery. Furthermore, the TE device 12 can be arranged in any desired configuration with respect to the battery 38. For example, the TE device 12 can be built into the battery assembly for the battery 38 or can form an enclosure surrounding the battery 38.

The system 10 further includes a controller 14, which may be a proportional/integral/derivative (PID) controller, for example. The controller 14 should be stable to environmental disturbances 36, such as heat losses and inflows, from the environment. The controller 14 may be any type of controller which is capable of changing the direction of electrical current through the Peltier circuit of the TE device 12 in order to heat or cool the battery 38 depending on a measured temperature of the battery 38, as will be hereinafter further described.

The controller 14 may include a temperature sensor 20 which is provided in thermally-conductive contact with the battery 38. The temperature sensor 20 measures the temperature of the battery 38 based on the reception of heat 34 from the battery 38. A comparator 18, the purpose of which will be hereinafter described, is connected to the temperature sensor 20. The temperature sensor 20 includes the capability to transmit an actual temperature transmission signal 28, which corresponds to the measured temperature (T) of the battery 38, to the comparator 18.

The controller 14 typically further includes a reference temperature database 16 into which reference temperature input 24 corresponding to a desired or reference temperature for the battery 38 may be programmed. The reference temperature (T_{ref}) for the battery 38 is the temperature which is required for optimum performance and durability of the battery 38. The reference temperature database 16 includes the capability to transmit a reference temperature transmission signal 26 to the comparator 18.

The comparator 18 is provided with the capability to compare the reference temperature (T_{ref}), received from the reference temperature database 16 via the reference temperature transmission signal 26, to the actual temperature (T) of the battery 38, received from the temperature sensor 20 via the actual temperature transmission signal 28, by calculating the temperature difference (e) according to the equation:
e=T−T_{ref}.
An actuator 22 is connected to the comparator 18 to receive a comparator output signal 30, which corresponds to the value of e, from the comparator 18. The actuator 22 is, in turn, connected to the TE device 12 to control the direction of current through the Peltier circuit in the TE device 12, via a control input signal 32, depending on the value of e.

In operation of the system 10, the reference temperature (T_{ref}) input 24, corresponding to the desired operational temperature for the battery 38, is initially programmed into the reference temperature database 16. During operation of the battery 38, the temperature sensor 20 continually measures the actual temperature (T) of the battery 38 responsive to input of heat 34 from the battery 34. The temperature sensor 20 transmits the actual temperature transmission signal 28, corresponding to the measured temperature (T) of the battery 38, to the comparator 18. Simultaneously, the reference temperature database 16 transmits the reference temperature transmission signal 26, corresponding to the reference temperature (T_{ref}), to the comparator 18.

The comparator 18 calculates the value of e by subtracting the value of T_{ref} from the value of T. Thus, in the event that T is higher than T_{ref}, e will have a positive value. This indicates an excessively high operational temperature of the battery 38. Therefore, the comparator 18 transmits the comparator output signal 30, which indicates the positive value of e, to the actuator 22. The actuator 22, in turn, causes flow of current through the Peltier circuit of the TE device 12 in a first direction to facilitate cooling of the battery 38, via the control input signal 32. Therefore, the value of T drops as the calculated value of e drops and approaches or reaches zero. At that point, the actuator 22, responsive to feedback control by the comparator 18 as facilitated by the temperature sensor 20 via the actual temperature transmission signal 28, terminates flow of current through the Peltier circuit of the TE device 12 in order to prevent further cooling of the battery 38 and maintain the value of T as close as possible to the value of T_{ref}. This ensures that the battery 38 operates at or near T_{ref} for optimum performance, reliability and duration of the battery 38.

In the event that T is lower than T_{ref}, the value of e as calculated by the comparator 18 will have a negative value. This indicates an excessively low operational temperature of the battery 38, as may be the case, for example, upon initial start-up of an automobile or during operation of the battery 38 in cold weather. In that case, the comparator 18 transmits the comparator output signal 30, which now indicates the negative value of e, to the actuator 22. Via the control input signal 32, the actuator 22, in turn, causes flow of current through the Peltier circuit of the TE device 12 in a second direction in order to facilitate heating of the battery 38. Therefore, T rises and approaches or reaches T_{ref} as the calculated value of e rises and approaches or reaches zero. At that point, the actuator 22, responsive to feedback control by the comparator 18 and the temperature sensor 20, terminates flow of current through the Peltier circuit of the TE device 12 in order to maintain the value of T as close as possible to the value of T_{ref}.

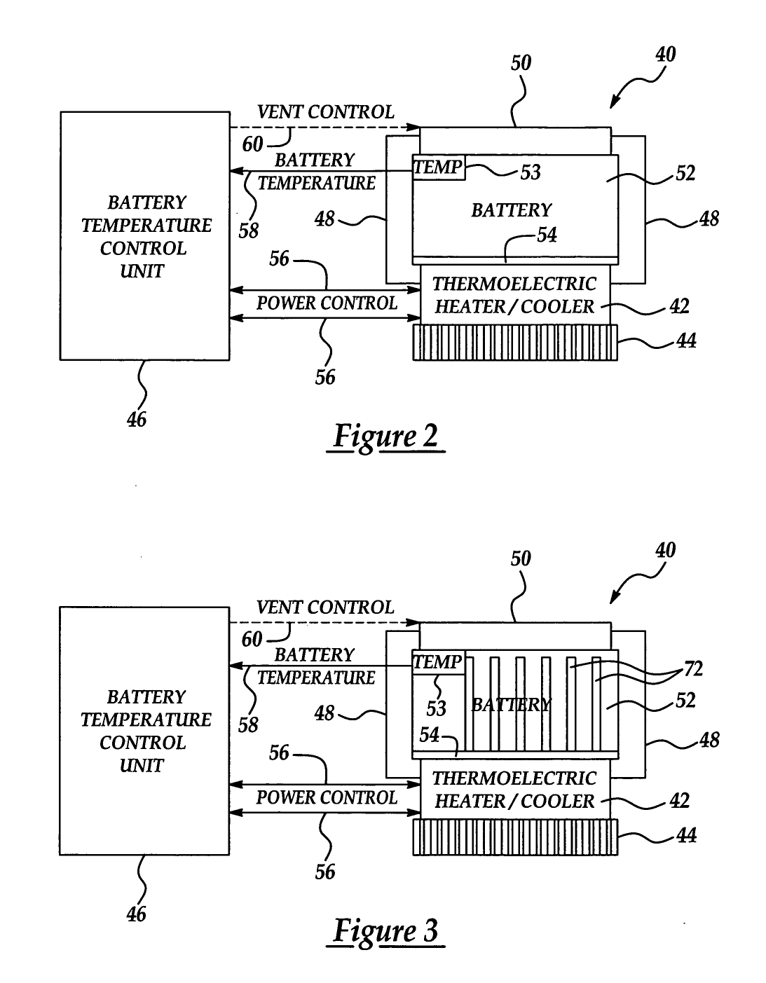

Referring next to FIG. 2, another illustrative embodiment of a thermoelectric (TE) battery control system, hereinafter system, of the present invention is generally indicated by reference numeral 40. The system 40 includes a thermoelectric (TE) device 42 which includes a conventional Peltier circuit (not shown). A battery 52, such as an automotive battery, for example, is disposed in thermally-conductive contact with one side of the TE device 42 typically through a thermal interface 54. The thermal interface 54 may be any suitable thermally-conductive material. Cooling fins 44 may be provided in thermally-conductive contact with the other side of the TE device 42.

The battery 52 may be contained inside a thermal enclosure 48, which may be any suitable thermally-insulating material. The thermal enclosure 48 serves to thermally insulate the battery 52 from environmental heat during operation. One or multiple controllable heat vents 50 may be provided in the thermal enclosure 48 to either retain heat in the thermal enclosure 48 or dissipate excessive heat from the battery 52 depending on the thermal requirements of the battery 52. A temperature sensor 53 is typically provided in thermal contact with the battery 52.

A battery temperature control unit 46 is connected to the temperature sensor 53. The temperature sensor 53 includes the capability to transmit temperature transmission signals 58, which correspond to a measured temperature of the battery 52, to the battery temperature control unit 46. The battery temperature control unit 46 may be connected to the heat vent or vents 50 to control the position of the vent or vents 50, via a vent control signal 60, depending on the measured temperature of the battery 52, as will be hereinafter described. The battery temperature control unit 46 is further connected to the TE device 42 to control the direction of current flow through the Peltier circuit, and therefore, facilitate heating or cooling of the battery 52, via TE device control signals 56, depending on the measured temperature of the battery 52. The battery temperature control unit 46 may be designed and programmed to utilize the same method as that heretofore described with respect to the temperature sensor 20, reference temperature database 16, comparator 18 and actuator 22 of the system 10 shown in FIG. 1 in order to determine and effect the heating and cooling requirements of the battery 52.

In operation of the system 40, a reference temperature which corresponds to the optimum operating temperature of the battery 52 is initially programmed into the battery temperature control unit 46. During operation of the battery 52, the temperature sensor 53 continually measures the temperature of the battery 52 and transmits this information, in the form of the temperature transmission signal 58, to the battery temperature control unit 46. In the event that the measured temperature of the battery 52 is higher than the reference temperature, the battery temperature control unit 46, via the TE device control signal 56, induces flow of current in a first direction through the Peltier circuit of the TE device 42. This causes cooling of the battery 52 in order to lower the measured temperature of the battery 52 to or near the reference temperature. Additionally, the battery temperature control unit 46, via the vent control signal 60, may facilitate opening of the vent or vents 50 to dissipate additional heat from the battery 52. As the TE device 42 cools the battery 52, the cooling fins 44 dissipate heat from the hot side of the TE device 42. This increases the battery-cooling efficiency of the TE device 42.

In the event that the measured temperature of the battery 52 is lower than the reference temperature, as may be the case during start-up of an automobile or during operation of the battery 52 in cold weather, for example, the battery temperature control unit 46, via the TE device control signal 56, induces flow of current in a second direction through the Peltier circuit of the TE device 42. Consequently, the temperature of the battery 52 rises and approaches or reaches the reference temperature. The battery temperature control unit 46, via the vent control signal 60, may additionally facilitate closing of the vent or vents 50 to retain heat in the thermal enclosure 48 and raise the temperature of the battery 52.

Referring next to FIG. 3, another illustrative embodiment of the TE battery control system, hereinafter system, of the present invention is generally indicated by reference numeral 70. The system 70 is similar in design to the system 40 heretofore described with respect to FIG. 2, except multiple heat-conductive strips 72 are packaged into the battery 52. The heat-conductive strips 72 may be suitable thermally-conductive material and facilitate efficient temperature control during operation of the battery 52 and system 70.

While the preferred embodiments of the invention have been described above, it will be recognized and understood that various modifications can be made in the invention and the appended claims are intended to cover all such modifications which may fall within the spirit and scope of the invention.

What is claimed is:

1. A method of controlling a temperature of a battery, comprising:
providing a thermoelectric device in thermally-conductive contact with said battery;
measuring an actual temperature of said battery;
comparing said actual temperature to a reference temperature for said battery;
heating said battery by operation of said thermoelectric device when said actual temperature is less than said reference temperature; and
cooling said battery by operation of said thermoelectric device when said actual temperature exceeds said reference temperature.

2. The method of claim 1 further comprising retaining heat in said battery when said actual temperature is less than said reference temperature.

3. The method of claim 1 further comprising venting heat from said battery when said actual temperature exceeds said reference temperature.

4. The method of claim 1 further comprising retaining heat in said battery when said actual temperature is less than said reference temperature and venting heat from said battery when said actual temperature exceeds said reference temperature.

5. The method of claim 1 further comprising thermally insulating said battery from environmental heat.

6. The method of claim 1 further comprising dissipating heat from said thermoelectric device.

7. The method of claim 6 further comprising thermally insulating said battery from environmental heat, retaining heat in said battery when said actual temperature is less than said reference temperature and venting heat from said battery when said actual temperature exceeds said reference temperature.

8. The method of claim 1 wherein said comparing said actual temperature to a reference temperature for said battery comprises calculating a temperature difference by subtracting said reference temperature from said actual temperature and cooling said battery when said temperature difference is a positive value and heating said battery when said temperature difference is a negative value.

9. A method of controlling a temperature of a battery, comprising:
providing a thermoelectric device in thermally-conductive contact with said battery;
thermally insulating said battery from environmental heat;
measuring an actual temperature of said battery;
establishing a reference temperature for said battery;
calculating a temperature difference by subtracting said reference temperature from said actual temperature;
heating said battery by operation of said thermoelectric device when said temperature difference is a negative value; and
cooling said battery by operation of said thermoelectric device when said temperature difference is a positive value.

10. The method of claim 9 further comprising retaining heat in said battery when said actual temperature is less than said reference temperature.

11. The method of claim 9 further comprising venting heat from said battery when said actual temperature exceeds said reference temperature.

12. The method of claim 9 further comprising dissipating heat from said thermoelectric device.

13. A thermoelectric battery control system for thermal control of a battery, comprising:
a thermoelectric device for placement in thermal contact with the battery; and
a controller operably connected to said thermoelectric device, said controller comprising a capability for comparing an actual temperature of the battery with a reference temperature for the battery and facilitating heating of the battery using said thermoelectric device when said actual temperature is less than said reference temperature and cooling of the battery using said thermoelectric device when said actual temperature exceeds said reference temperature.

14. The system of claim 13 wherein said controller comprises a temperature sensor for sensing said actual temperature of the battery.

15. The system of claim 14 wherein said controller further comprises a comparator operably connected to said temperature sensor for receiving an actual temperature transmission signal from said temperature sensor and comparing said actual temperature to said reference temperature.

16. The system of claim 15 further comprising an actuator operably connected to said comparator and said thermoelectric device for receiving a comparator output signal from said comparator and actuating said thermoelectric device.

17. A thermoelectric battery control system for thermal control of a battery, comprising:
a thermoelectric device for placement in thermal contact with the battery; and
a controller operably connected to said thermoelectric device for actuating said thermoelectric device to heat the battery when an actual temperature of the battery is less than a reference temperature for the battery and actuating said thermoelectric device to cool the battery when said actual temperature exceeds said reference temperature.

18. The system of claim 17 further comprising a plurality of cooling fins provided in thermally-conductive contact with said thermoelectric device for dissipating heat from said thermoelectric device.

19. The system of claim 17 further comprising a thermal enclosure engaging said thermoelectric device for containing the battery and thermally isolating the battery from environmental heat.

20. The system of claim 19 further comprising at least one vent provided in said thermal enclosure for dissipating heat from the battery.

21. The system of claim 17 further comprising a plurality of heat-conductive strips provided in said thermal enclosure for engaging the battery.
